(19) United States
(12) Patent Application Publication
(10) Pub. No.: US 2004/0149109 A1
(43) Pub. Date: Aug. 5, 2004

(54) Support for linear motion especially suitable for cutting units

(76) Inventor: Elio Cavagna, Melegnano (IT)

Correspondence Address: ABELMAN, FRAYNE & SCHWAB, 150 EAST 42ND STREET, NEW YORK, NY, 10017-5612, US

(21) Appl. No.: 10/728,605

(22) Filed: Dec. 4, 2003

(30) Foreign Application Priority Data
Feb. 3, 2003 (IT) MI2003U000043

(51) Int. Cl. B26D 7/28; B26D 1/12; B26B 1/00

(52) U.S. Cl. 83/639.1; 83/663; 83/698.11

(57) ABSTRACT

A support for linear motion may be especially combined with cutting units or groups of machine tools for the continuous cutting of laminar materials such as films, paper, plastic, fabric films, and the like. The support is connected to a beam or sliding guide of the machine tools, and the support includes a shaped metal block having a first seat and a second seat. A brake is placed in the first seat, and a sliding device is housed in the second seat, with the sliding device being constituted by at least a ball monorail guidance system connected to a shaped sliding track fastened to the beam or sliding guide.

### BACKGROUND OF THE INVENTION

1. Field of the Invention

The present invention relates to a support for linear motion, especially suitable for cutting units or cutting groups of machine tools. More particularly, the present invention relates to a support especially suitable for the linear motion of trolleys with which cutting groups are generally combined, having blade holders and counter-blade holders carrying out the continuous cutting of laminar materials of different kinds, in the form of film such as paper, plastic, fabric film, and the like.

2. Description of the Related Art

It is known that, in order to carry out this cutting of laminar materials, specific machine tools are used wherein the different cutting groups are placed, by means of the mentioned trolleys, along a beam or sliding guide extending lengthwise. On the same guide, the cutting groups are generally motioned by means of automatic controls for the correct reciprocal spacing according to the size-width of the bands and strips to be obtained from the laminar material that uncoils from a reel.

The motion and the positioning of the various cutting groups along the beam or sliding guide causes serious drawbacks due to the fact that they take place according to mechanical couplings of shape.

In fact, the trolleys carrying the single cutting groups and the sliding guide are traditionally provided with shaped connections, generally dovetail-shaped connections, inevitably involving friction. Notwithstanding the regular lubrication and cleaning operations to remove slag or small foreign matter, the trolleys often slide in an imprecise and non-homogeneous way causing alterations to the foreseen and planned reciprocal spacing among tools or cutting units. Moreover, the grazing friction of the sliding members, in time, may cause backslashes giving rise to considerable restart operations generating subsequent costs, and therefore an interruption of the production cycle is required.

### BRIEF SUMMARY OF THE INVENTION

An object of the present invention is to solve the above-mentioned drawbacks.

More particularly, an object of the present invention is to provide a support for linear motion, especially suitable for cutting groups combined with machine tools which carry out the continuous cutting of laminar materials, allowing the homogeneous and constant sliding and the subsequent precise positioning of the groups along the relevant sliding guide.

A further object of the present invention is to provide a support as described herein allowing a substantial reduction of the friction of the sliding members and the subsequent backslashes forming in time, thus removing the need of considerable restart operations.

A further object of the present invention is to provide a support for the linear motion assuring a high resistance and reliability level in time, which may be also easily manufactured and at a low cost.

These and other purposes resulting from the description herein may be attained by a support for linear motion which may be especially applied to cutting groups sliding on guides of machine tools for the continuous cutting of laminar materials connected to a beam or sliding guide of the machines, in which the support includes a shaped metal block having a first seat and a second seat. A brake is placed in the first seat, and a sliding device is housed in the second seat, with the sliding device being constituted by at least a ball monorail guidance system combined with a shaped sliding track housed in the second seat.

### BRIEF DESCRIPTION OF THE SEVERAL VIEWS OF THE DRAWINGS

The manufacturing and functional features of the support for linear motion of the present invention will be better understood from the detailed description herein, with reference being made to the FIGURES of the attached drawing with:

FIG. 1 representing a partially-sectioned side schematic view of a preferred and non-limiting embodiment of the support for linear motion of the present invention.

### DETAILED DESCRIPTION OF THE INVENTION

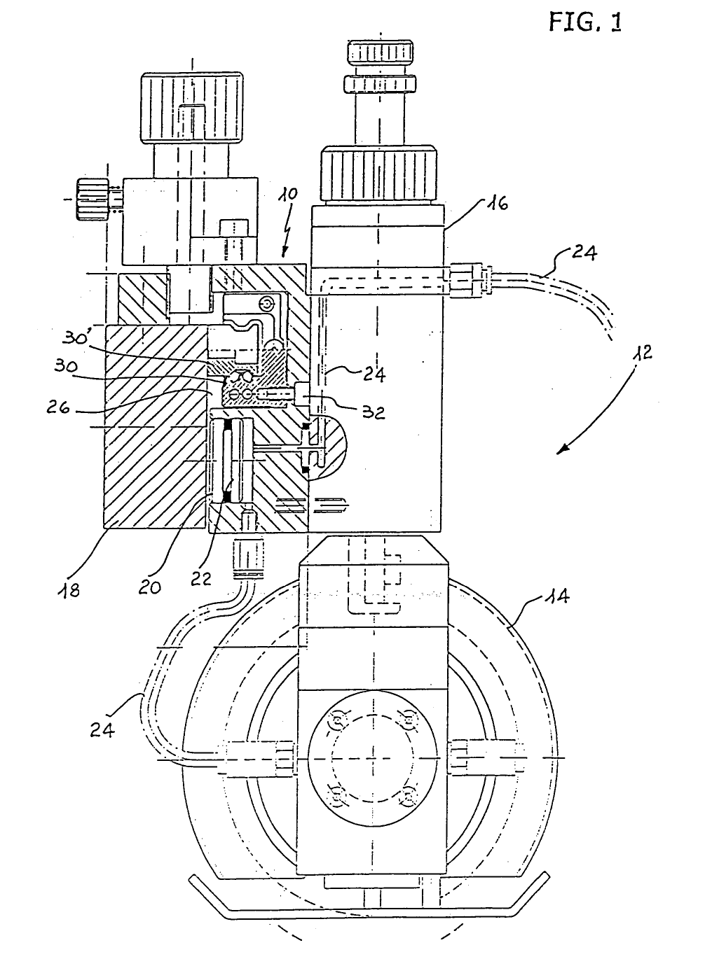

With reference to FIG. 1, the support 10 of the present invention is advantageously combined with machine tools for carrying out the continuous cutting of laminar materials. The support 10 is fastened to each cutting group 12 of a machine tool, having a known blade 14 and known means 16 for providing vertical motion of the blade 14 approaching a counter-blade. The support 10 is preferably composed of an irregularprism-shaped metal block, and is connected, in a sliding arrangement, to the beam 18 of the machine tool. The support 10 is provided with a first seat 20 opposite to the beam 18, in which a conventional brake 22 is placed.

The brake 22 is pneumatically or hydraulically operated through a working fluid developing within a duct 24, elongated into the motion means 16 of each group 12 and partially and externally positioned relative to each group 12 for the motion of the blade 14. According to the preferred embodiment, the support 10 includes a second seat 26 which is preferably formed on top and substantially adjacent to or near to the first seat 20, with the second seat 26 adapted to house a sliding device or unit 30 matching at least partly with the beam or guide 18. The sliding device or unit 30 includes at least a ball monorail guidance system, for example, of the type known in the marked with the name “INA/KUVE”, and the sliding device 30 is fastened to the support 10 by one or more screws 32 or equivalent means.

The ball monorail guidance system 30 is combined with a shaped track 30′ along which the system slides. The track 30′ substantially extends along the whole length of the beam 18 to which the track 30′ is fastened by screws or equivalent means. By means of screws or equivalent fastening means, a plurality of single supports 10 slide independently one from the other along the track 30′together with the ball monorail guidance system of the unit 30, and the plurality of single supports 10 allows for linear motion of the various cutting groups 12, with each of the groups 12 being integral to a respective single support 10.

The experimental verifications which have been carried out have demonstrated that the solution according to the present invention undoubtedly improves the sliding or linear motion conditions and the relevant positioning of the single cutting groups 12 whose translation is constantly homogeneous, progressing, and with reduced friction, which allows for the precise positioning of the same groups 12, and avoiding at the same time the danger of backslashes and of subsequent restart operations.

Even though the present invention has been described herein with reference to an embodiment which is given by way of a non-limiting example, various changes and variants may be made which are clear to a technician according to the above-mentioned description. Therefore, the present invention is meant to include all changes and variants falling within the spirit and the protective scope of the following claims.

What is claimed is:

1. A support (10) for linear motion that can be especially combined with cutting groups (12) of machine tools for the continuous cutting of laminar materials such as films, paper, plastic, fabric films, and the like, the support (10) being connected to a beam or sliding guide (18) of the machine tools, the support (10) comprising:
a shaped metal block having:
a first seat (20); and
a second seat (26);
wherein the first seat (20) includes:
a brake (22) positioned in the first seat (20); and
wherein the second seat (26) includes:
a sliding device (30) housed in the second seat (26), with the sliding device (30) including at least a ball monorail guidance system connected to a shaped sliding track (30′) fastened to the beam (18).

2. The support according to claim 1, wherein the shaped track (30′) substantially extends along the whole length of the beam (18), and the shaped track (30′) is fastened to the beam (18) by screws or equivalent fastening means.

3. The support according to claim 1, wherein the second seat (26) is formed substantially adjacent to the first seat (20); and
wherein the brake (22) is placed in the second seat (26) for cooperating with the cutting groups (12), with the brake (22) being pneumatically operated.

4. The support according to claim 2, wherein the second seat (26) is formed substantially adjacent to the first seat (20); and
wherein the brake (22) is placed in the second seat (26) for cooperating with the cutting groups (12), with the brake (22) being pneumatically operated.

5. The support according to claim 1, wherein the second seat (26) is formed substantially adjacent to the first seat (20); and
wherein the brake (22) is placed in the second seat (26) for cooperating with the cutting groups (12), with the brake (22) being hydraulically operated.

6. The support according to claim 2, wherein the second seat (26) is formed substantially adjacent to the first seat (20); and
wherein the brake (22) is placed in the second seat (26) for cooperating with the cutting groups (12), with the brake (22) being hydraulically operated.

7. The support according to claim 1, wherein the sliding device (30) is fastened to the support by screws (32) or similar fastening means.

8. The support according to claim 2, wherein the sliding device (30) is fastened to the support by screws (32) or similar fastening means.

9. The support according to claim 3, wherein the sliding device (30) is fastened to the support by screws (32) or similar fastening means.

10. The support according to claim 4, wherein the sliding device (30) is fastened to the support by screws (32) or similar fastening means.

11. The support according to claim 5, wherein the sliding device (30) is fastened to the support by screws (32) or similar fastening means.

12. The support according to claim 6, wherein the sliding device (30) is fastened to the support by screws (32) or similar fastening means.

13. A support for linear motion for use with a cutting machine tool for the continuous cutting of laminar materials such as films, paper, plastic, fabric films, and the like, the support being connected to a beam or sliding guide of the machine tool, the support comprising:
a shaped metal block having:
a first seat; and
a second seat;
a brake positioned in the first seat; and
a sliding device housed in the second seat, with the sliding device connected to a sliding track fastened to the beam.

14. The support according to claim 13, wherein the sliding track substantially extends along the whole length of the beam, and the sliding track is fastened to the beam by fastening means.

15. The support according to claim 13, wherein the second seat is formed substantially adjacent to the first seat; and
wherein the brake is placed in the second seat for cooperating with the cutting machine tool, with the brake being pneumatically operated.

16. The support according to claim 14, wherein the second seat is formed substantially adjacent to the first seat; and
wherein the brake is placed in the second seat for cooperating with the cutting machine tool, with the brake being pneumatically operated.

17. The support according to claim 13, wherein the second seat is formed substantially adjacent to the first seat; and
wherein the brake is placed in the second seat for cooperating with the cutting machine tool, with the brake being hydraulically operated.

18. The support according to claim 14, wherein the second seat is formed substantially adjacent to the first seat; and
wherein the brake is placed in the second seat for cooperating with the cutting machine tool, with the brake being hydraulically operated.

19. The support according to claim 13, wherein the sliding device is fastened to the metal block by fastening means.

20. A support for linear motion for use with a cutting machine tool for the continuous cutting of laminar materials such as films, paper, plastic, fabric films, and the like, the support being connected to a beam or sliding guide of the machine tool, the support comprising:
a shaped block having:
a first seat; and
a second seat;
a brake positioned in the first seat; and
a sliding device housed in the second seat, with the sliding device connected to a sliding track fastened to the beam and fastened to the shaped block by fastening means.
